(19) United States
(12) Patent Application Publication
(10) Pub. No.: US 2023/0001822 A1
(43) Pub. Date: Jan. 5, 2023

(54) SYSTEMS AND METHODS FOR PREDICTIVE ENERGY MANAGEMENT FOR HIGH-VOLTAGE AND LOW-VOLTAGE RECHARGEABLE ENERGY STORAGE SYSTEMS OF VEHICLES

(71) Applicant: Cummins Inc., Columbus, IN (US)

(72) Inventors: Lin Huang, Wuhan (CN); Jun Tang, Wuhan (CN)

(21) Appl. No.: 17/853,486

(22) Filed: Jun. 29, 2022

(30) Foreign Application Priority Data
Jun. 30, 2021 (CN) 202110737270.0

(51) Int. Cl. B60L 58/13; B60L 58/20; B60L 53/22; H02M 3/335; H02J 7/00

(52) U.S. Cl. CPC B60L 58/13; B60L 58/20; B60L 53/22; H02M 3/33584; H02J 7/0048; H02J 7/0019; B60L 2240/547; H02J 2310/48; H02J 2207/20; B60L 2210/14; B60L 2210/12

(57) ABSTRACT

At least some embodiments of the present disclosure are directed to systems and methods for predictive energy management for an electrified powertrain. In some embodiments, the system is configured to: receive a first state-of-charge (SOC) of a high-voltage energy storage system; receive a second SOC of a low-voltage energy storage system; predict an energy recuperation of an electrified powertrain using telematics data; and determine a charging direction of a bidirectional converter based on the predicted energy recuperation, the first SOC, and the second SOC.

### CROSS-REFERENCE TO RELATED APPLICATIONS

This application claims priority to Chinese Patent Application No. 202110737270.0, filed Jun. 30, 2021, the entire contents of which are incorporated herein by reference.

### TECHNICAL FIELD

The present disclosure generally relates to predictive energy management for high-voltage and low-voltage energy storage systems of vehicles, including a determination of charging direction and parameters between the high-voltage and low-voltage energy storage systems.

### BACKGROUND

Recently, there has been an increased demand for vehicles with electrified powertrains to improve fuel economy and reduce emissions, e.g., vehicles with multiple forms of motive power. Some electrified powertrains include an engine (e.g., internal combustion engine), motor/generator(s) and energy storage systems (e.g., battery(s)). Some electrified powertrains include motor/generator(s) and energy storage systems (e.g., battery(s)). When the battery(s) is(are) sufficiently charged, the electrified powertrain can operate without using the engine. Some electrified powertrains are powered only by electricity, such as battery(s). The batteries are rechargeable via variable means.

### SUMMARY

Electrified powertrains often include a high-voltage rechargeable energy storage system (REESS) (e.g., fuel cell(s), battery(s), battery bank, etc.) and a low-voltage rechargeable. The high voltage REESS is normally for propulsion and recuperation, the low voltage REESS is used for power supply of low voltage accessories, such as starting system, lighting system, etc. Electrified powertrains are capable of recuperating energy into the high-voltage REESS. The capacity of low voltage REESS is normally large and the low-voltage REESS is lower in cost with equivalent energy storage capacity of high-voltage REESS, while low-voltage REESS has low charging/discharging rate.

If the state of charge (SOC) of high-voltage REESS is high before recuperation and the charging capacity of the high-voltage REESS is limited, the energy recuperation cannot be all used in recharging the high-voltage REESS, such that the optimum fuel economy cannot be achieved. In some embodiments, a bidirectional converter is used to charge and discharge either high-storage REESS and low-voltage REESS. In certain embodiments, a predictive energy management system is configured to predict the timing and amount of upcoming energy recuperation and manage the energy flow between the high-voltage REESS and low-voltage REES to provide adequate energy capacity for vehicle operation and charging capacity for energy recuperation. For example, before energy recuperation occurs, the predictive energy management system is configured to reduce the charge level of the high-voltage REESS by transferring energy from the high-voltage REESS to the low voltage REESS.

As recited in examples, Example 1 is a system of predictive energy management for an electrified powertrain, the electrified powertrain comprising a high-voltage rechargeable energy storage system (REESS) and a low-voltage REESS. The system comprises one or more memories having instructions; and one or more processors configured to execute the instructions to perform operations. The operations comprise receiving a first state-of-charge (SOC) of a high-voltage energy storage system; receiving a second SOC of a low-voltage energy storage system; predicting an energy recuperation of an electrified powertrain using telematics data; and determining a charging direction of a bidirectional converter based on the predicted energy recuperation, the first SOC, and the second SOC.

Example 2 is the system of Example 1, wherein the operations further comprise: determining a charging time of the bidirectional converter based on the predicted energy recuperation, the first SOC, and the second SOC.

Example 3 is the system of Example 1 or 2, wherein the operations further comprise: predicting a power usage of the electrified powertrain using the telematics data;

wherein the determining a charging direction comprises determining the charging direction of the bidirectional converter based on the predicted power usage, the predicted energy recuperation, the first SOC, and the second SOC.

Example 4 is the system of any one of Examples 1-3, wherein the operations further comprise: determining the first SOC at a low state; determining the second SOC at a high state; and determining the charging direction to be energy flowing from the low-voltage energy storage system to the high-voltage energy storage system.

Example 5 is the system of any one of Examples 1-4, wherein the operations further comprise: determining the first SOC at a high state; determining the second SOC at a low state; and determining the charging direction to be energy flowing from the high-voltage energy storage system to the low-voltage energy storage system.

Example 6 is the system of any one of Examples 1-5, wherein the operations further comprise: determining the first SOC at a high state; determining the second SOC at a low state; predicting a power usage of the electrified powertrain using the telematics data; and in response to the predicted power usage being high for a first time period, determining no energy flowing between the high-voltage energy storage system and the low-voltage energy storage system during the first time period.

Example 7 is the system of Example 6, wherein the operations further comprise: determining the charging direction to be energy flowing from the high-voltage energy storage system to the low-voltage energy storage system during a second time period; wherein the second time period is after the first time period.

Example 8 is the system of any one of Examples 1-7, wherein the operations further comprise: determining a charging capacity of the high-voltage energy storage system; wherein: the predicted energy recuperation comprises an amount of the predicted energy recuperation; the determining a charging direction comprises: comparing the charging capacity and the amount of predicted energy recuperation to generate a comparison result; and determining the charging direction of the bidirectional converter based on the comparison result, the first SOC, and the second SOC.

Example 9 is the system of any one of Examples 1-8, wherein the operations further comprise: comparing the first SOC with an SOC range to generate an SOC comparison result, the SOC range comprising a high SOC threshold and a low SOC threshold; wherein the determining a charging direction comprises determining the charging direction of the bidirectional converter based at least in part on the SOC comparison result.

Example 10 is the system of any one of Examples 1-9, wherein the operations further comprise: in response to the SOC comparison result indicating the first SOC being lower than the high SOC threshold, determining the charging direction to be energy flowing from the low-voltage storage system to the high-voltage storage system.

Example 11 is a method implemented by an energy management unit including one or more processors, the method comprising: receiving a first state-of-charge (SOC) of a high-voltage energy storage system; receiving a second SOC of a low-voltage energy storage system; predicting an energy recuperation of an electrified powertrain using telematics data; and determining a charging direction of a bidirectional converter based on the predicted energy recuperation, the first SOC, and the second SOC.

Example 12 is the method of Example 11, further comprising: determining a charging time of the bidirectional converter based on the predicted energy recuperation, the first SOC, and the second SOC.

Example 13 is the method of Example 11 or 12, further comprising: predicting a power usage of the electrified powertrain using the telematics data; wherein the determining a charging direction comprises determining the charging direction of the bidirectional converter based on the predicted power usage, the predicted energy recuperation, the first SOC, and the second SOC.

Example 14 is the method of any one of Examples 11-13, further comprising: determining the first SOC at a low state; determining the second SOC at a high state; and determining the charging direction to be energy flowing from the low-voltage energy storage system to the high-voltage energy storage system.

Example 15 is the method of any one of Examples 11-14, further comprising: determining the first SOC at a high state; determining the second SOC at a low state; and determining the charging direction to be energy flowing from the high-voltage energy storage system to the low-voltage energy storage system.

Example 16 is the method of any one of Examples 11-15, further comprising: determining the first SOC at a high state; determining the second SOC at a low state; predicting a power usage of the electrified powertrain using the telematics data; and in response to the predicted power usage being high for a first time period, determining no energy flowing between the high-voltage energy storage system and the low-voltage energy storage system during the first time period.

Example 17 is the method of Example 16, further comprising: determining the charging direction to be energy flowing from the high-voltage energy storage system to the low-voltage energy storage system during a second time period; wherein the second time period is after the first time period.

Example 18 is the method of any one of Examples 11-17, further comprising: determining a charging capacity of the high-voltage energy storage system; wherein: the predicted energy recuperation comprises an amount of the predicted energy recuperation; the determining a charging direction comprises: comparing the charging capacity and the amount of predicted energy recuperation to generate a comparison result; and determining the charging direction of the bidirectional converter based on the comparison result, the first SOC, and the second SOC.

Example 19 is the method of any one of Examples 11-18, further comprising: comparing the first SOC with an SOC range to generate an SOC comparison result, the SOC range comprising a high SOC threshold and a low SOC threshold; wherein the determining a charging direction comprises determining the charging direction of the bidirectional converter based at least in part on the SOC comparison result.

Example 20 is the method of any one of Examples 11-19, further comprising: in response to the SOC comparison result indicating the first SOC being lower than the high SOC threshold, determining the charging direction to be energy flowing from the low-voltage storage system to the high-voltage storage system.

Example 21 is an apparatus coupled to one or more processors, the apparatus comprising: a bidirectional converter configured to operate in a plurality of charging modes. The plurality of charging modes comprise a first charging mode for energy flowing from a high-voltage rechargeable energy storage system (REESS) to a low-voltage REESS. The plurality of charging modes further comprise a second charging mode for energy flowing from the low-voltage REESS to the high-voltage REESS. The bidirectional converter is configured to receive a charging direction indication from the one or more processors, where the charging direction indication is determined based at least in part upon a predicted energy recuperation of an electrified powertrain using telematics data. The bidirectional converter is configured to set to one of the plurality of charging modes based at least in part upon the charging direction indication.

Example 22 is the apparatus of Example 21, wherein the plurality of charging modes further comprise a third charging mode for no energy transfer.

Example 23 is the apparatus of Example 21 or 22, wherein the charging direction indication is determined based at least in part upon a first state-of-charge (SOC) of the high-voltage REESS and a second SOC of the low-voltage REESS.

Example 24 is the apparatus of any one of Examples 21-23, wherein the charging direction indication is determined based at least in part upon predicted power usage of the electrified powertrain using the telematics data.

Example 25 is the apparatus of any one of Examples 21-24, wherein the charging direction indication is determined based at least in part upon a comparison between a determined charging capacity of the high-voltage REESS using the first SOC and an amount of the predicted energy recuperation.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 depicts an illustrative diagram of one exemplary predictive energy management system for an electrified powertrain, in accordance with certain embodiments of the subject matter of the disclosure;

FIG. 2A is an example flow diagram depicting an illustrative method of predictive energy management of an electrified powertrain, in accordance with embodiments of the present disclosure;

FIG. 2B is an example flow diagram depicting an illustrative method of predictive energy management of an electrified powertrain, in accordance with embodiments of the present disclosure; and

FIGS. 3A-3D are illustrative examples of predictive energy management with various SOC states.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, when an element, component, device or layer is described as being “on” “connected to,” “coupled to” or “in contact with” another element, component, device or layer, it can be directly on, directly connected to, directly coupled with, in direct contact with, or intervening elements, components, devices or layers may be on, connected, coupled or in contact with the particular element, component or layer, for example. When an element, component, device or layer for example is referred to as being “directly on,” “directly connected to,” “directly coupled to,” or “directly in contact with” another element, component, device or layer, there are no intervening elements, components, devices or layers for example.

Although illustrative methods may be represented by one or more drawings (e.g., flow diagrams, communication flows, etc.), the drawings should not be interpreted as implying any requirement of, or particular order among or between, various steps disclosed herein. However, certain some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” “series” or “group” of items (e.g., inputs, algorithms, data values, etc.) may include one or more items, and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information.

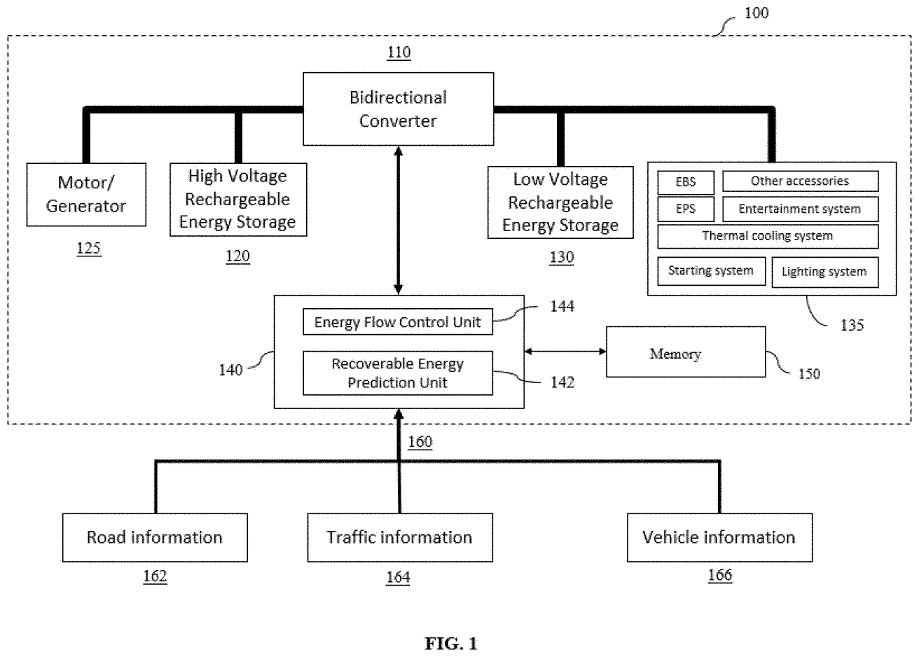

FIG. 1 depicts an illustrative diagram of one exemplary predictive energy management system 100 for an electrified powertrain, in accordance with certain embodiments of the subject matter of the disclosure. In some implementations, one or more components of the system 100 can be optional. In some implementations, the system 100 can include other components not illustrated in the diagram. In the illustrated example, the predictive energy management system 100 includes a bidirectional converter 110, a high-voltage rechargeable energy storage system (REESS) 120, a motor/generator 125, a low voltage rechargeable energy storage system 130, an accessory system 135, a controller 140, and a memory 150. In some designs, the motor/generator 125 is configured to provide traction power to the vehicle. In some embodiments, the predictive energy management system 100 is configured to receive telematics data 160 from various internal and external systems. The telematics data 160 includes road information 162, traffic information 164, and vehicle information 166, and/or other telematics data. In some implementations, the bidirectional converter 110 is a direct current (DC) to DC converter.

In some embodiments, the accessory system 135 includes one or more of electronic braking system (EBS), electric power steering (EPS), entertainment system, thermal cooling system, starting system, lighting system, and other accessories. In certain embodiments, the controller 140 is configured to receive road information 162 and traffic information 164 via a software interface (e.g., API, web service, etc.). In some examples, the controller 140 is configured to receive road information 162 and traffic information 164 by retrieving the data from a data repository, such as a data repository that is a part of the memory 150.

In some cases, the controller 140 is configured to receive vehicle information 166 such as, for example, the SOC of the high-voltage REESS, the SOC of the low-voltage REESS, accessories power consumption, speed, power level of the engine, torque, brake thermal efficiency (BTE), and/or the like. The vehicle information may also include vehicle sensor data such as, for example, noise data, vibration data, harshness data, exhaust gas temperature, catalyst temperature, altitude data, and/or the like. In some embodiments, the vehicle includes an altitude sensor, for example, a barometric sensor.

In some embodiments, the controller 140 includes a recoverable energy prediction unit 142 configured to predict energy recuperation and an energy flow control unit 144 configured to control the energy flow direction (e.g., charging, discharging, etc.) between the high-voltage REESS 120 and the low-voltage REESS 130. In certain embodiments, at least a part of the recoverable energy prediction unit 142 is implemented in a backend fleet managing program. In some examples, the controller 140 and/or the recoverable energy prediction unit 142 uses the route information and speed of the vehicle to predict an energy recuperation possible when the vehicle is going downhill. In certain examples, the controller 140 and/or the recoverable energy prediction unit 142 uses the route information and traffic information to predict an energy recuperation possible when the vehicle is braking. In some examples, the controller 140 and/or the recoverable energy prediction unit 142 uses information (e.g., road information 162) from a backend fleeting managing program to predict an energy recuperation.

In certain embodiments, the controller 140 receives a state-of-charge (SOC) of the high-voltage REESS 120 and receives a SOC of a low-voltage REESS 130. In some examples, the controller 140 and/or the recoverable energy prediction unit 142 is configured to predict an energy recuperation using telematics data 160. In some embodiments, the predicted energy recuperation includes a plurality of energy recuperation parameters, such as the timing (i.e., in 20 minutes) and the amount of the energy recuperation (e.g., 0.5 walt). In some examples, the length and the slope of the downhill route is used to determine the plurality of energy recuperation parameters.

In some embodiments, the controller 140 and/or the energy flow control unit 144 controls the bidirectional converter 110 based on the predicted energy recuperation, the SOC of the high-voltage REESS 120, and the SOC of the low-voltage REESS 130. In some examples, the bidirectional converter control includes a plurality of charging parameters, such as a charging direction, a charging time, a charging duration, a target mode, a target current, a target voltage, and/or the like. In some examples, the target mode of the bidirectional converter includes an error mode indicating an error of the electrified powertrain system, a converter buck mode indicating energy flow into the high-voltage REESS 120, a converter boost mode indicating energy flow into the low-voltage REESS 130, and a converter standby mode indicating no energy transfer between the high-voltage REESS 120 and low-voltage REESS 130. In certain embodiments, the controller 140 and/or the energy flow control unit 144 uses a predetermined SOC range including a high SOC threshold (e.g., 85%) and a low SOC threshold (e.g., 15%) in determining the charging parameters. In some examples, the predetermined SOC range includes a second SOC threshold indicating a normal operation level of a corresponding REESS.

In some embodiments, the charging parameters includes the charging time and the controller 140 is configured to determine the charging time based on the predicted energy recuperation, the SOC of the high-voltage REESS 120, and the SOC of the low-voltage REESS 130. In certain embodiments, the controller 140 is configured to predict a power usage of the electrified powertrain using the telematics data 160 and use the predicted power usage in determining charging parameters of the bidirectional converter 110.

In some embodiments, the controller 140 predicts the amount of the energy recuperation based on the telematics data 160. In some examples, the controller 140 determines a charging capacity of the high-voltage REESS 120. In certain examples, the controller 140 compares the charging capacity of the high-voltage REESS 120 with the amount of the energy recuperation and determines charging parameters of the bidirectional converter 110. In one example, the controller 140 determines the charging capacity to be lower than the amount of the energy recuperation and determines and controls the charging direction to be energy flow from the high-voltage REESS 120 to the low-voltage REESS 130, and the target mode of the bidirectional converter 110 to be the converter boost mode. In one example, the controller 140 determines the charging capacity to be lower than the amount of the energy recuperation and determines and controls the target mode of the bidirectional converter to be the standby mode. In one example, the controller 140 determines the charging capacity to be lower than the amount of the energy recuperation, and determines the SOC of the low-voltage REESS 130 to be higher than the high SOC threshold, and determines and controls the target mode of the bidirectional converter 110 to be the standby mode.

In some embodiments, the controller 140 determines the SOC of the high-voltage REESS 120 at a low state. In some examples, the SOC of the high-voltage REESS 120 at a low state when the SOC of the high-voltage REESS 120 is lower than a low SOC operational threshold (e.g., 30%). In some examples, the SOC range includes the low SOC operational threshold (e.g., 30%) and a high SOC operational threshold (e.g., 60%). In certain examples, the controller 140 compares the SOC of the high-voltage REESS 120 with the low SOC operational threshold and the high SOC operational threshold. In response to the SOC of the high-voltage REESS 120 at the low state, the controller 140 may determine the charging direction to be energy flow from the low-voltage REESS 130 to the high-voltage REESS 120, and the target mode of the bidirectional converter 110 to be the converter buck mode.

In certain embodiments, the controller 140 determines the SOC of the low-voltage REESS 130 at a high state. In some examples, the SOC of the low-voltage REESS 130 at a high state when the SOC of the low-voltage REESS 130 is higher than the high SOC operational threshold. In certain examples, the controller 140 compares the SOC of the low-voltage REESS 130 with the low SOC threshold and the high SOC threshold. In response to the SOC of the low-voltage REESS 130 at the high state, the controller 140 may determine the charging direction to be energy flow from the low-voltage REESS 130 to the high-voltage REESS 120, and the target mode of the bidirectional converter 110 to be the converter buck mode.

In some embodiments, the controller 140 determines the SOC of the high-voltage REESS 120 at a high state. In some examples, the SOC of the high-voltage REESS 120 at a high state when the SOC of the high-voltage REESS 120 is higher than the high SOC operational threshold. In response to the SOC of the high-voltage REESS 120 at the high state, the controller 140 may determine the charging direction to be energy flow from the high-voltage REESS 120 to the low-voltage REESS 130, and the target mode of the bidirectional converter 110 to be the converter boost mode.

In certain embodiments, the controller 140 determines the SOC of the low-voltage REESS 130 at a low state. In some examples, the SOC of the low-voltage REESS 130 at a low state when the SOC of the low-voltage REESS 130 is lower than the low SOC operational threshold. In response to the SOC of the low-voltage REESS 130 at the low state, the controller 140 may determine the charging direction to be energy flow from the high-voltage REESS 120 to the low-voltage REESS 130, and the target mode of the bidirectional converter 110 to be the converter boost mode.

In some embodiments, the controller 140 determines the SOC of the high-voltage REESS 120 at a high state. In some examples, the SOC of the high-voltage REESS 120 at a high state when the SOC of the high-voltage REESS 120 is higher than the high SOC operational threshold. In certain examples, the controller 140 predicts a first power usage of the electrified powertrain using the telematics data 160, where the first power usage is determined to be high. In response to the SOC of the high-voltage REESS 120 at the high state and the predicted first power usage to be high, the controller 140 may determine no energy flow between the high-voltage REESS 120 to the low-voltage REESS 130, and the target mode of the bidirectional converter 110 to be the standby mode at a first time. In some examples, the controller 140 predicts a second power usage of the electrified powertrain using the telematics data 160, where the second power usage is determined to be low. In response to the predicted second power usage to be low, the controller may determine the charging direction to be energy flow from the high-voltage REESS 120 to the low-voltage REESS 130, and the target mode of the bidirectional converter 110 to be the converter boost mode at a second time, where the second time is after the first time.

In certain embodiments, the controller 140 determines the SOC of the low-voltage REESS 130 at a low state. In some examples, the SOC of the low-voltage REESS 130 at a low state when the SOC of the low-voltage REESS 130 is lower than the low SOC operational threshold. In certain examples, the controller 140 predicts a first power usage of the electrified powertrain using the telematics data 160, where the first power usage is determined to be high.

In response to the SOC of the low-voltage REESS 130 at the low state and the predicted first power usage to be high, the controller 140 may determine no energy flow between the high-voltage REESS 120 to the low-voltage REESS 130, and the target mode of the bidirectional converter 110 to be the standby mode at a first time. In some examples, the controller 140 predicts a second power usage of the electrified powertrain using the telematics data 160, where the second power usage is determined to be low. In response to the predicted second power usage to be low, the controller may determine the charging direction to be energy flow from the high-voltage REESS 120 to the low-voltage REESS 130, and the target mode of the bidirectional converter 110 to be the converter boost mode at a second time, where the second time is after the first time.

In some embodiments, the predictive energy management system 100 is configured to provide energy back to a power grid (e.g., power grid for an area). In some examples, the SOC of the high-voltage REESS 120 and/or the SOC of the low-voltage REESS 130 are at high states and energy flows back to the power grid.

In certain embodiments, a computing device (e.g., the controller 140, the recoverable energy prediction unit 142, the energy flow control unit 144) includes a bus that, directly and/or indirectly, couples the following devices: a processor, a memory, an input/output (I/O) port, an I/O component, and a power supply. Any number of additional components, different components, and/or combinations of components may also be included in the computing device. The bus represents what may be one or more busses (such as, for example, an address bus, data bus, or combination thereof). Similarly, in some embodiments, the computing device may include a number of processors, a number of memory components, a number of I/O ports, a number of I/O components, and/or a number of power supplies. Additionally, any number of the components (e.g., the controller 140, the recoverable energy prediction unit 142, the energy flow control unit 144) of the predictive energy management system 100, or combinations thereof, may be distributed and/or duplicated across a number of computing devices (e.g., portable devices, on-board computers, backend systems, etc.).

In some embodiments, the memory 150 includes computer-readable media in the form of volatile and/or nonvolatile memory, transitory and/or non-transitory storage media and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; and/or any other medium that can be used to store information and can be accessed by a computing device such as, for example, quantum state memory, and/or the like. In some embodiments, the memory 150 stores computer-executable instructions for causing a processor (e.g., the controller 140) to implement aspects of embodiments of system components discussed herein and/or to perform aspects of embodiments of methods and procedures discussed herein.

Computer-executable instructions may include, for example, computer code, machine-useable instructions, and the like such as, for example, program components capable of being executed by one or more processors associated with a computing device. Program components may be programmed using any number of different programming environments, including various languages, development kits, frameworks, and/or the like. Some or all of the functionality contemplated herein may also, or alternatively, be implemented in hardware and/or firmware.

The data repository (not shown), which is a part of the memory 150, may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

Various components of the predictive energy management system 100 can communicate via or be coupled to via a communication interface, for example, a wired or wireless interface. The communication interface includes, but is not limited to, any wired or wireless short-range and long-range communication interfaces. The wired interface can use cables, wires, and/or the like. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

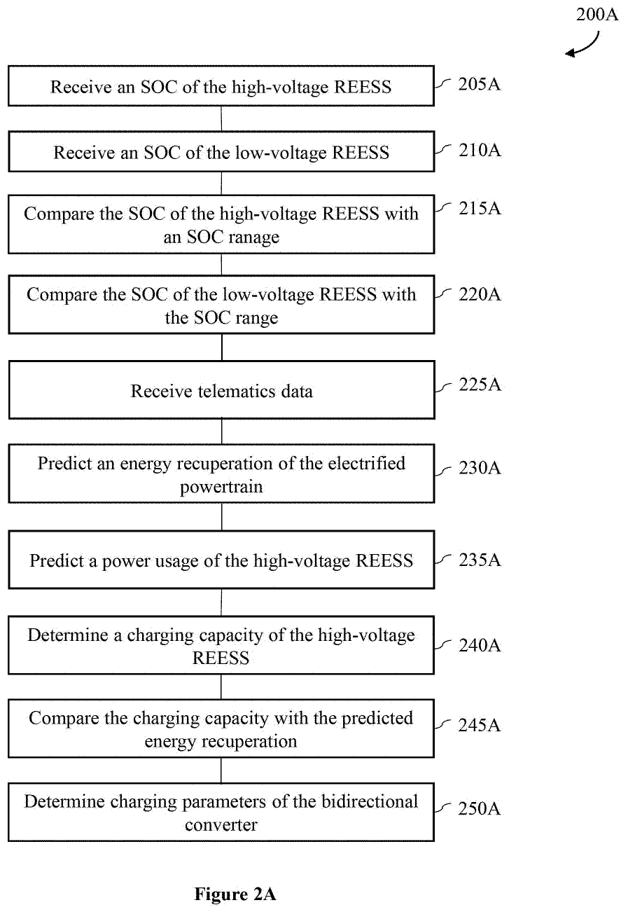

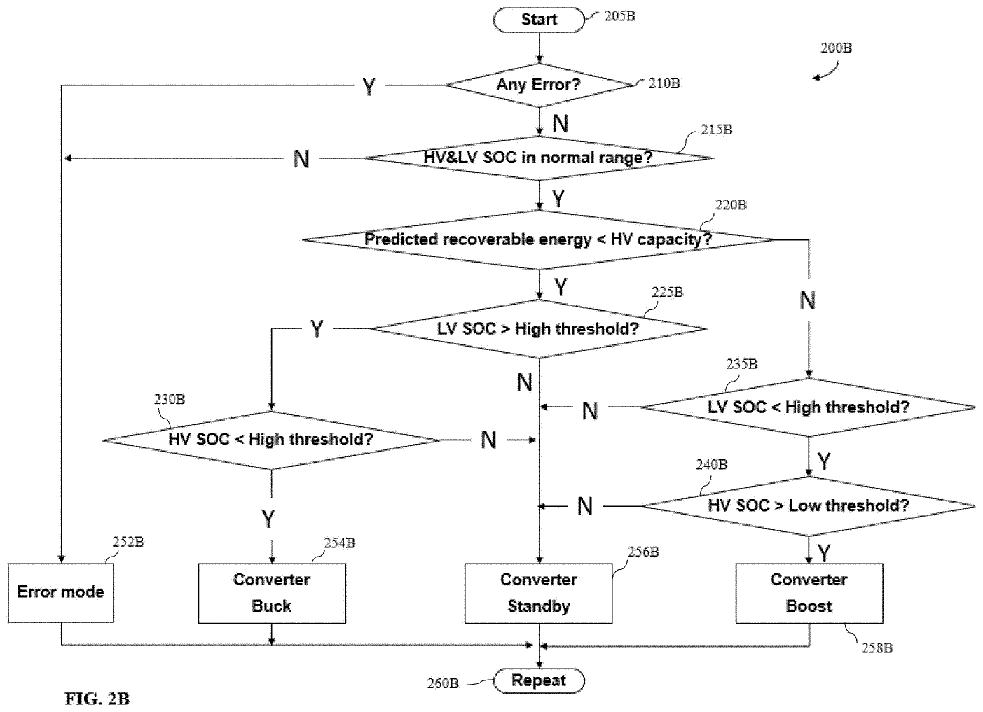

FIG. 2A is an example flow diagram depicting an illustrative method 200A of predictive energy management of an electrified powertrain, in accordance with embodiments of the present disclosure. Aspects of embodiments of the method 200A may be performed, for example, by a controller for an electrified powertrain (e.g., the controller 140 in FIG. 1). One or more steps of method 200A are optional and/or can be modified by one or more steps of other embodiments described herein. Additionally, one or more steps of other embodiments described herein may be added to the method 200A. The electrified powertrain includes a high-voltage REESS (e.g., the high-voltage REESS 120 in FIG. 1), a low-voltage REESS (e.g., the low-voltage REESS 130 in FIG. 1), and a bidirectional converter (e.g., the bidirectional converter 110 in FIG. 1). In some embodiments, the controller receives an SOC of the high-voltage REESS (205A) and receives an SOC of the low-voltage REESS (210A).

In certain embodiments, the controller compares the SOC of the high-voltage REESS with an SOC range (215A), where the SOC range includes a low SOC threshold (e.g., 15%) and a high SOC threshold (e.g., 85%). The controller may determine whether the SOC of the high-voltage REESS is lower than the low SOC threshold and whether the SOC of the high-voltage REESS is higher than the high SOC threshold. In some embodiments, the controller compares the SOC of the low-voltage REESS with the SOC range (220A). The controller may determine whether the SOC of the low-voltage REESS is lower than the low SOC threshold and whether the SOC of the low-voltage REESS is higher than the high SOC threshold. In some examples, the predetermined SOC range includes a desired SOC level (e.g., 60%) indicating a normal operation level of a corresponding REESS.

In some examples, the controller receives telematics data (225A) including, for example, the road information, the traffic information, and the vehicle information. In certain examples, the controller is configured to receive road information and traffic information via a software interface (e.g., API, web service, etc.). In some examples, the controller is configured to receive road information and traffic information via retrieve the data from a data repository (e.g., the memory 150 in FIG. 1). In some cases, the controller is configured to receive vehicle information 166 such as, for example, the SOC of the high-voltage REESS, the SOC of the low-voltage REESS, accessories power consumption, speed, power level of the engine, torque, brake thermal efficiency (BTE), and/or the like. The vehicle information may also include vehicle sensor data such as, for example, noise data, vibration data, harshness data, exhaust gas temperature, catalyst temperature, altitude data, and/or the like. In some embodiments, the vehicle includes an altitude sensor, for example, a barometric sensor.

In some embodiments, the controller predicts an energy recuperation of the electrified powertrain (230A), for example, using telematics data. In some embodiments, the predicted energy recuperation includes a plurality of energy recuperation parameters, such as the timing (i.e., in 20 minutes) and the amount of the energy recuperation (e.g., 0.5 walt). In some examples, the length and the slope of the downhill route is used to determine the plurality of energy recuperation parameters.

In certain embodiments, the controller predicts a power usage of the electrified powertrain using the telematics data (235A). In some embodiments, the controller determines a charging capacity of the high-voltage REESS (240A) and compares the charging capacity of the high-voltage REESS with the predicted energy recuperation (245A).

In some embodiments, the controller determines charging parameters of the bidirectional converter (250A), for example, based on at least the predicted energy recuperation, the SOC of the high-voltage REESS, and the SOC of the low-voltage REESS, the predicted power usage, the determined charging capacity of the high-voltage REESS, and/or a combination thereof. In some examples, the charging parameters include, for example, a charging direction, a charging time, a charging duration, a target mode, a target current, a target voltage, and/or the like. In some examples, the target mode of the bidirectional converter includes an error mode indicating an error of the electrified powertrain system, a converter buck mode indicating energy flow into the high-voltage REESS, a converter boost mode indicating energy flow into the low-voltage REESS, and a converter standby mode indicating no energy transfer between the high-voltage REESS and the low-voltage REESS.

In some embodiments, the controller is configured to determine the charging time and charging duration based on the predicted energy recuperation, the SOC of the high-voltage REESS, and the SOC of the low-voltage REESS. In certain examples, the controller compares the charging capacity of the high-voltage REESS with the amount of the energy recuperation and determines charging parameters of the bidirectional converter. In one example, the controller determines the charging capacity to be lower than the amount of the energy recuperation and determines and controls the charging direction to be energy flow from the high-voltage REESS to the low-voltage REESS, and the target mode of the bidirectional converter to be the converter boost mode. In one example, the controller determines the charging capacity to be lower than the amount of the energy recuperation and determines and controls the target mode of the bidirectional converter to be the standby mode. In one example, the controller determines the charging capacity to be lower than the amount of the energy recuperation, and determines the SOC of the low-voltage REESS to be higher than the high SOC threshold, and determines and controls the target mode of the bidirectional converter to be the standby mode.

In some embodiments, the controller determines the SOC of the high-voltage REESS at a low state. In some examples, the SOC of the high-voltage REESS at a low state when the SOC of the high-voltage REESS is lower than the low SOC operational threshold. In certain examples, the controller compares the SOC of the high-voltage REESS with the low SOC threshold and the high SOC threshold. In response to the SOC of the high-voltage REESS at the low state, the controller may determine the charging direction to be energy flow from the low-voltage REESS to the high-voltage REESS 120, and the target mode of the bidirectional converter to be the converter buck mode.

In certain embodiments, the controller determines the SOC of the low-voltage REESS at a high state. In some examples, the SOC of the low-voltage REESS at a high state when the SOC of the low-voltage REESS 130 is higher than the high SOC operational threshold. In certain examples, the controller compares the SOC of the low-voltage REESS with the low SOC threshold and the high SOC threshold. In response to the SOC of the low-voltage REESS at the high state, the controller may determine the charging direction to be energy flow from the low-voltage REESS to the high-voltage REESS, and the target mode of the bidirectional converter to be the converter buck mode.

In some embodiments, the controller determines the SOC of the high-voltage REESS at a high state. In some examples, the SOC of the high-voltage REESS at a high state when the SOC of the high-voltage REESS is higher than the high SOC operational threshold. In response to the SOC of the high-voltage REESS at the high state, the controller may determine the charging direction to be energy flow from the high-voltage REESS to the low-voltage REESS 130 and the target mode of the bidirectional converter to be the converter boost mode.

In certain embodiments, the controller determines the SOC of the low-voltage REESS at a low state. In some examples, the SOC of the low-voltage REESS 130 at a low state when the SOC of the low-voltage REESS is lower than the low SOC operational threshold. In response to the SOC of the low-voltage REESS at the low state, the controller may determine the charging direction to be energy flow from the high-voltage REESS to the low-voltage REESS, and the target mode of the bidirectional converter to be the converter boost mode.

In some embodiments, the controller determines the SOC of the high-voltage REESS at a high state. In some examples, the SOC of the high-voltage REESS at a high state when the SOC of the high-voltage REESS is higher than the high SOC operational threshold. In certain examples, the controller predicts a first power usage of the electrified powertrain using the telematics data, where the first power usage is determined to be high. In response to the SOC of the high-voltage REESS at the high state and the predicted first power usage to be high, the controller may determine no energy flow between the high-voltage REESS to the low-voltage REESS, and the target mode of the bidirectional converter to be the standby mode at a first time. In some examples, the controller predicts a second power usage of the electrified powertrain using the telematics data, where the second power usage is determined to be low. In response to the predicted second power usage to be low, the controller may determine the charging direction to be energy flow from the high-voltage REESS to the low-voltage REESS, and the target mode of the bidirectional converter to be the converter boost mode at a second time, where the second time is after the first time.

In certain embodiments, the controller determines the SOC of the low-voltage REESS at a low state. In some examples, the SOC of the low-voltage REESS at a low state when the SOC of the low-voltage REESS is lower than the low SOC operational threshold. In certain examples, the controller predicts a first power usage of the electrified powertrain using the telematics data, where the first power usage is determined to be high. In response to the SOC of the low-voltage REESS at the low state and the predicted first power usage to be high, the controller may determine no energy flow between the high-voltage REESS to the low-voltage REESS, and the target mode of the bidirectional converter to be the standby mode at a first time. In some examples, the controller predicts a second power usage of the electrified powertrain using the telematics data, where the second power usage is determined to be low. In response to the predicted second power usage to be low, the controller may determine the charging direction to be energy flow from the high-voltage REESS 120 to the low-voltage REESS, and the target mode of the bidirectional converter 110 to be the converter boost mode at a second time, where the second time is after the first time.

FIG. 2B is an example flow diagram depicting an illustrative method 200B of predictive energy management of an electrified powertrain, in accordance with embodiments of the present disclosure. Aspects of embodiments of the method 200B may be performed, for example, by a controller for an electrified powertrain (e.g., the controller 140 in FIG. 1). One or more steps of method 200B are optional and/or can be modified by one or more steps of other embodiments described herein. Additionally, one or more steps of other embodiments described herein may be added to the method 200B. The electrified powertrain includes a high-voltage REESS (e.g., the high-voltage REESS 120 in FIG. 1), a low-voltage REESS (e.g., the low-voltage REESS 130 in FIG. 1), and a bidirectional converter (e.g., the bidirectional converter 110 in FIG. 1). The controller starts the process (205B).

In some embodiments, the controller evaluates whether the electrification powertrain has any error (210B). If there is error, the controller sets the energy management to the error mode (252B) and the energy management process will not be used. If there is no error, the controller checks whether the SOC of the high-voltage REESS and the SOC of the low-voltage REESS are in normal SOC range (e.g., 15%-85%) (215B). If either one of the SOC of the high-voltage REESS and the SOC of the low-voltage REESS is not in the normal range, the controller sets the energy management to the error mode (252B). If the SOC of the high-voltage REESS and the SOC of the low-voltage REESS are in normal SOC range, the controller predicts recoverable energy (i.e., an amount of the energy recuperation), determines the charging capacity of the high-voltage REESS, and compares the predicted recoverable energy and the charging capacity (220B).

If the predicted recoverable energy is less than the charging capacity, the controller compares the SOC of the low-voltage REESS with the high SOC threshold (225B). If the SOC of the low-voltage REESS is higher than the high SOC threshold, the controller compares the SOC of the high-voltage REESS with the high SOC threshold (230B). If the SOC of the high-voltage REESS is lower than the high SOC threshold, the controller sets the bidirectional converter to be the converter buck mode (254B), where the bidirectional converter is configured to transfer energy from the low-voltage REESS to the high-voltage REESS.

If the SOC of the low-voltage REESS is higher than the high SOC threshold and the SOC of the high-voltage REESS is higher than the high SOC threshold, the controller sets the bidirectional converter to the converter standby mode (256B), with no energy transferring between the low-voltage REESS and the high-voltage REESS.

If the predicted recoverable energy is greater than the charging capacity, the controller determines whether the low-voltage REESS is lower than the high SOC threshold (235B). If the SOC of the low-voltage REESS is not lower than the high SOC threshold, the controller sets the bidirectional converter to the converter standby mode (256B). If the SOC of the low-voltage REESS is lower than the high SOC threshold, the controller determines whether the SOC of the high-voltage REESS is higher than the low SOC threshold (240B). If the SOC of the high-voltage REESS is higher than the low SOC threshold, the controller sets the bidirectional converter to the converter boost mode (258B), where the bidirectional converter is configured to transfer energy from the high-voltage REESS to the low-voltage REESS. If the SOC of the high-voltage REESS is not higher than the low SOC threshold, the controller sets the bidirectional converter to the converter standby mode (256B), with no energy transferring between the low-voltage REESS and the high-voltage REESS. The controller will repeat (260B) the process from the start (205B).

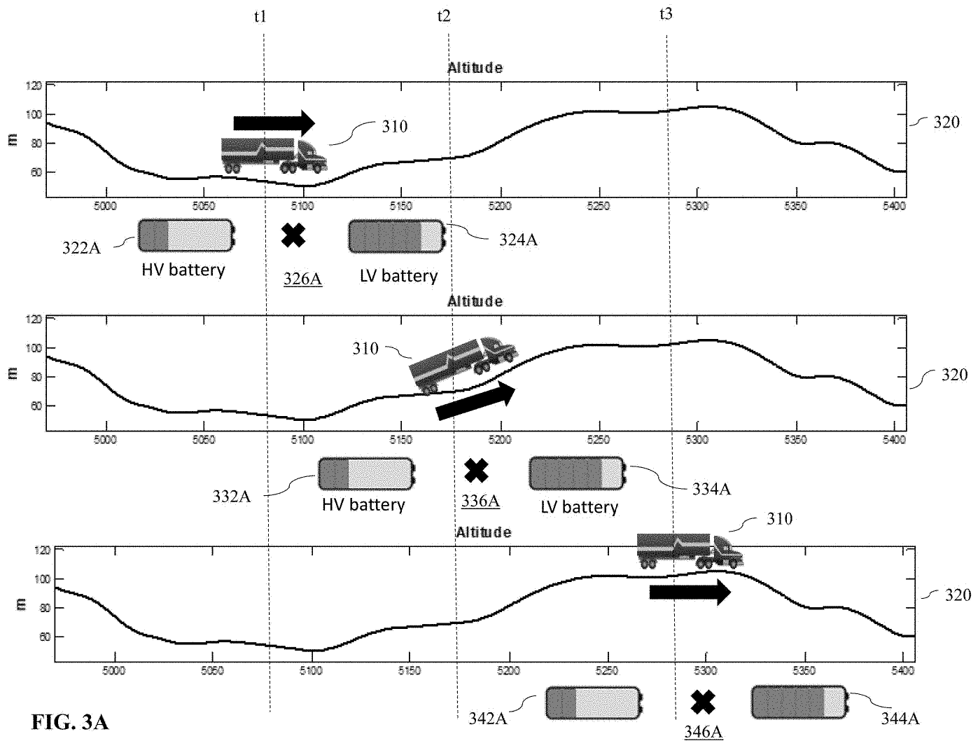

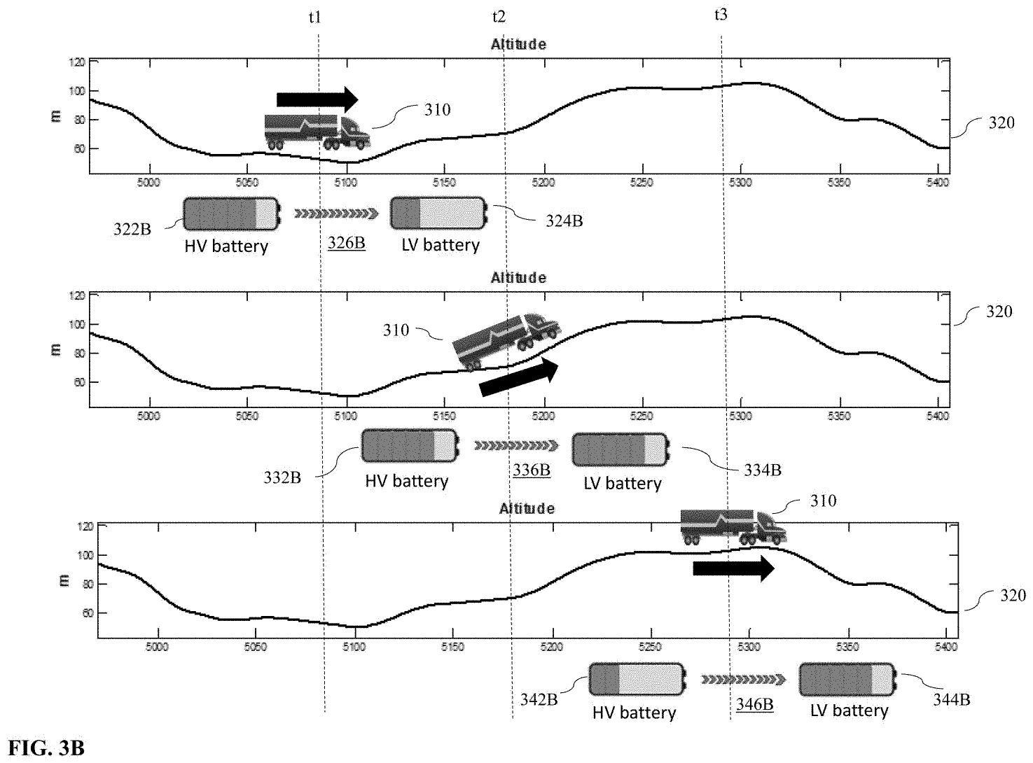

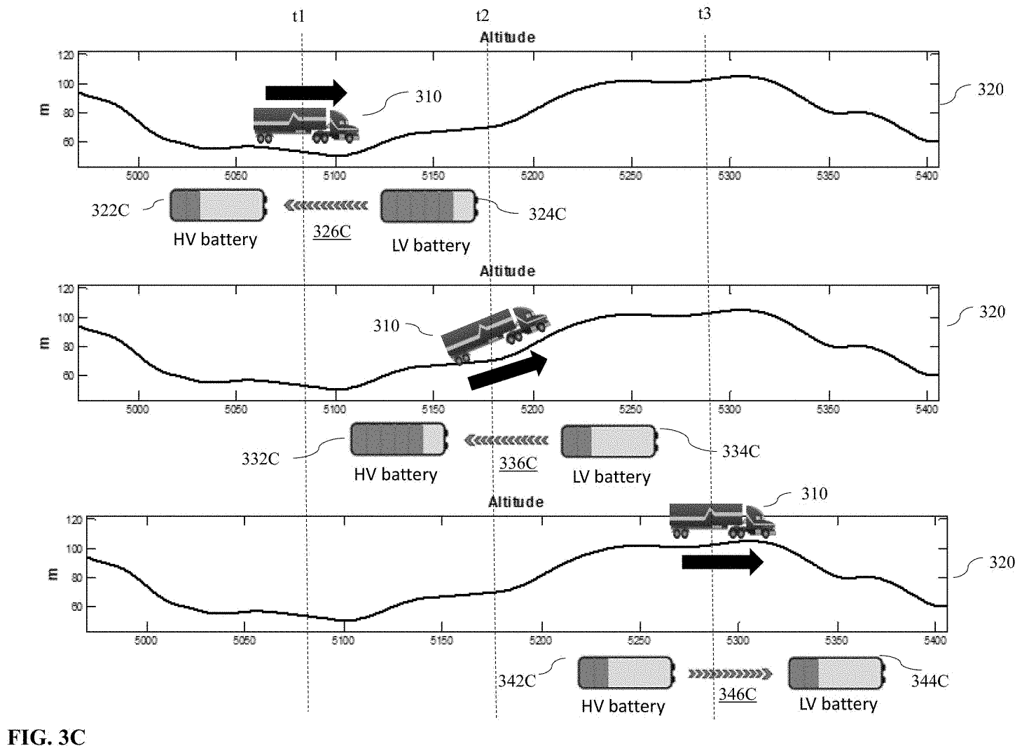

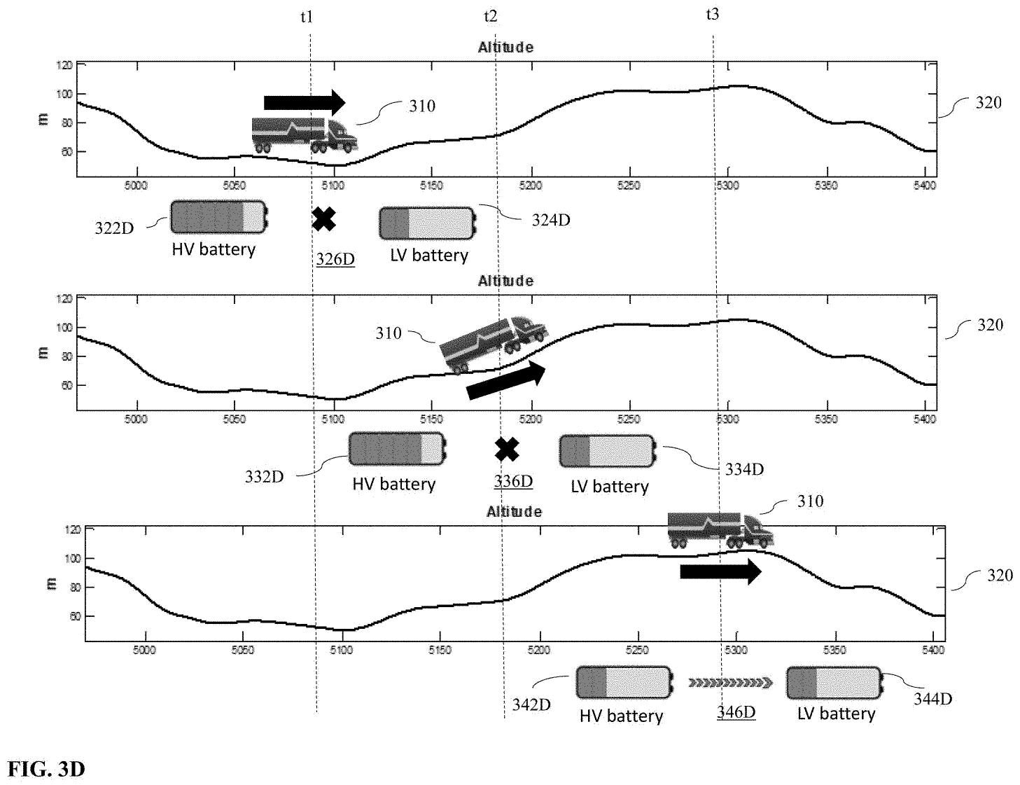

FIGS. 3A-3D are illustrative examples of predictive energy management with various SOC states. As illustrated in FIG. 3A, a predictive energy management system of an electrified powertrain determines a route 320 of a vehicle 310 based on telematics data. The electrified powertrain of the electrified powertrain includes a high-voltage battery (e.g., a type of high-voltage rechargeable energy storage system), a low-voltage battery (e.g., a type of low-voltage rechargeable energy storage system), and a bidirectional converter configured to transfer energies between the high-voltage battery and the low-voltage battery. The route 320 includes timing information and altitude information. The predictive energy management system monitors the SOC of the high-voltage battery and the SOC of the low-voltage battery.

The predictive energy management system predicts a high power usage of the vehicle 310 between t1 and t3 and predicts energy recuperation after t3 because of altitude changes. The predictive energy management system may also determine the charging capacity of the high-voltage battery and determine that the charging capacity is greater than the predicted energy recuperation. At t1, the SOC of the high-voltage battery is at a low state 322A, such that the charging capacity of the high-voltage battery is higher than the predicted energy recuperation, the SOC of the low-voltage battery is at a high state 324A, and the bidirectional converter is at a standby mode 326A. At t2 and t3, with no energy transfer at a previous time, the SOC of the high-voltage battery remains at a low state 332A and 342A, the SOC of the low-voltage battery remains at a high state 334A and 344A, and the bidirectional converter is at standby mode 336A and 346A.

As illustrated in FIG. 3B, the predictive energy management system of an electrified powertrain determines the same route 320 as illustrated in FIG. 3A of the vehicle 310 based on telematics data. The predictive energy management system predicts a high power usage of the vehicle 310 between t1 and t3 and predicts energy recuperation after t3 because of altitude changes. The predictive energy management system may also determine the charging capacity of the high-voltage battery and determine that the charging capacity is lower than the predicted energy recuperation. At t1, the SOC of the high-voltage battery is at a high state 322B, such that the charging capacity of the high-voltage battery is lower than the predicted energy recuperation, the SOC of the low-voltage battery is at a low state 324B, and the bidirectional converter is at a converter boost mode 326B with energy flow from the high-voltage battery to the low-voltage battery. At t2, the SOC of the high-voltage battery is at a high state 332B and the SOC of the low-voltage batter is at a high state 334B, the determined charging capacity of the high-voltage battery is lower than the predicted energy recuperation, and the bidirectional converter is at the converter booster mode 336B. At t3, the SOC of the high-voltage battery is at a low state 342B, the SOC of the low-voltage battery is at a high state 344B, the determined charging capacity is larger than the predicted energy recuperation, and the bidirectional converter is at the converter boost mode 346B.

As illustrated in FIG. 3C, the predictive energy management system of an electrified powertrain determines the same route 320 as illustrated in FIG. 3A of the vehicle 310 based on telematics data. The predictive energy management system predicts a high power usage of the vehicle 310 between t1 and t3 and predicts energy recuperation after t3 because of altitude changes. The predictive energy management system may also determine the charging capacity of the high-voltage battery and determine that the charging capacity is higher than the predicted energy recuperation. At t1, the SOC of the high-voltage battery is at a high state 322C, such that the charging capacity of the high-voltage battery is higher than the predicted energy recuperation, the SOC of the low-voltage battery is at a high state 324C, and the bidirectional converter is at a converter buck mode 326C with energy flow from the low-voltage battery to the high-voltage battery with the predicted power usage to be high. At t2, the SOC of the high-voltage battery is at a high state 332C and the SOC of the low-voltage batter is at a high state 334C, the predicted power usage of the vehicle is high, and the bidirectional converter is at the converter buck mode 336C. At t3, the SOC of the high-voltage battery is at a low state 342C, the SOC of the low-voltage battery remains at a low state 344C, the determined charging capacity is larger than the predicted energy recuperation, and the bidirectional converter is at the converter boost mode 346C with energy flow from the high-voltage battery to the low-voltage battery.

As illustrated in FIG. 3D, the predictive energy management system of an electrified powertrain determines the same route 320 as illustrated in FIG. 3A of the vehicle 310 based on telematics data. The predictive energy management system predicts a high power usage of the vehicle 310 between t1 and t3 and predicts energy recuperation after t3. The predictive energy management system may also determine the charging capacity of the high-voltage battery and determine that the charging capacity is lower than the predicted energy recuperation. At t1, the SOC of the high-voltage battery is at a high state 322D, such that the charging capacity of the high-voltage battery is lower than the predicted energy recuperation, the SOC of the low-voltage battery is at a low state 324D, and the bidirectional converter is at a converter standby mode 326D without energy flow with the predicted power usage to be high. At t2, the SOC of the high-voltage battery is at a high state 332D and the SOC of the low-voltage batter is at a low state 334D, the determined charging capacity of the high-voltage battery is lower than the predicted energy recuperation, and the bidirectional converter is at the converter standby mode 336D. At t3, the SOC of the high-voltage battery is at a low state 342D, the SOC of the low-voltage battery remains at a low state 344D, the determined charging capacity is larger than the predicted energy recuperation, and the bidirectional converter is at the converter boost mode 346D with energy flow from the high-voltage battery to the low-voltage battery.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

What is claimed is:

1. A system of predictive energy management for an electrified powertrain, the electrified powertrain comprising a high-voltage rechargeable energy storage system (REESS) and a low-voltage REESS, the system comprising:
one or more memories having instructions; and
one or more processors configured to execute the instructions to perform operations comprising:
receiving a first state-of-charge (SOC) of the high-voltage REESS;
receiving a second SOC of the low-voltage REESS;
predicting an energy recuperation of an electrified powertrain using telematics data; and
determining a charging direction of a bidirectional converter based on the predicted energy recuperation, the first SOC, and the second SOC.

2. The system of claim 1, wherein the operations further comprise:
determining a charging time of the bidirectional converter based on the predicted energy recuperation, the first SOC, and the second SOC.

3. The system of claim 1, wherein the operations further comprise:
predicting a power usage of the electrified powertrain using the telematics data;
wherein the determining a charging direction comprises determining the charging direction of the bidirectional converter based on the predicted power usage, the predicted energy recuperation, the first SOC, and the second SOC.

4. The system of claim 1, wherein the operations further comprise:
determining the first SOC at a low state;
determining the second SOC at a high state; and
determining the charging direction to be energy flowing from the low-voltage energy storage system to the high-voltage REESS.

5. The system of claim 1, wherein the operations further comprise:
determining the first SOC at a high state;
determining the second SOC at a low state; and
determining the charging direction to be energy flowing from the high-voltage REESS to the low-voltage REESS.

6. The system of claim 1, wherein the operations further comprise:
determining the first SOC at a high state;
determining the second SOC at a low state;
predicting a power usage of the electrified powertrain using the telematics data; and
in response to the predicted power usage being high for a first time period, determining no energy flowing between the high-voltage REESS and the low-voltage REESS during the first time period.

7. The system of claim 6, wherein the operations further comprise:
determining the charging direction to be energy flowing from the high-voltage energy storage system to the low-voltage energy storage system during a second time period;
wherein the second time period is after the first time period.

8. The system of claim 1, wherein the operations further comprise:
determining a charging capacity of the high-voltage REESS;
wherein:
the predicted energy recuperation comprises an amount of the predicted energy recuperation;
the determining a charging direction comprises:
comparing the charging capacity and the amount of predicted energy recuperation to generate a comparison result; and
determining the charging direction of the bidirectional converter based on the comparison result, the first SOC, and the second SOC.

9. The system of claim 1, wherein the operations further comprise:
comparing the first SOC with an SOC range to generate an SOC comparison result, the SOC range comprising a high SOC threshold and a low SOC threshold;
wherein the determining a charging direction comprises determining the charging direction of the bidirectional converter based at least in part on the SOC comparison result.

10. The system of claim 1, wherein the operations further comprise:
in response to the SOC comparison result indicating the first SOC being lower than the high SOC threshold, determining the charging direction to be energy flowing from the low-voltage REESS to the high-voltage REESS.

11. A method implemented by an energy management unit including one or more processors, the method comprising:
receiving a first state-of-charge (SOC) of a high-voltage energy storage system;
receiving a second SOC of a low-voltage energy storage system;
predicting an energy recuperation of an electrified powertrain using telematics data; and
determining a charging direction of a bidirectional converter based on the predicted energy recuperation, the first SOC, and the second SOC.

12. The method of claim 11, further comprising:
determining a charging time of the bidirectional converter based on the predicted energy recuperation, the first SOC, and the second SOC.

13. The method of claim 11, further comprising:
predicting a power usage of the electrified powertrain using the telematics data;
wherein the determining a charging direction comprises determining the charging direction of the bidirectional converter based on the predicted power usage, the predicted energy recuperation, the first SOC, and the second SOC.

14. The method of claim 11, further comprising:
determining the first SOC at a low state;
determining the second SOC at a high state; and
determining the charging direction to be energy flowing from the low-voltage energy storage system to the high-voltage energy storage system.

15. The method of claim 11, further comprising:
determining the first SOC at a high state;
determining the second SOC at a low state; and
determining the charging direction to be energy flowing from the high-voltage energy storage system to the low-voltage energy storage system.

16. The method of claim 11, further comprising:
determining the first SOC at a high state;
determining the second SOC at a low state;
predicting a power usage of the electrified powertrain using the telematics data; and
in response to the predicted power usage being high for a first time period, determining no energy flowing between the high-voltage energy storage system and the low-voltage energy storage system during the first time period.

17. The method of claim 16, further comprising:
determining the charging direction to be energy flowing from the high-voltage energy storage system to the low-voltage energy storage system during a second time period;
wherein the second time period is after the first time period.

18. The method of claim 11, further comprising:
determining a charging capacity of the high-voltage energy storage system;
wherein:
the predicted energy recuperation comprises an amount of the predicted energy recuperation;
the determining a charging direction comprises:
comparing the charging capacity and the amount of predicted energy recuperation to generate a comparison result; and
determining the charging direction of the bidirectional converter based on the comparison result, the first SOC, and the second SOC.

19. The method of claim 11, further comprising:
comparing the first SOC with an SOC range to generate an SOC comparison result, the SOC range comprising a high SOC threshold and a low SOC threshold;
wherein the determining a charging direction comprises determining the charging direction of the bidirectional converter based at least in part on the SOC comparison result.

20. The method of claim 11, further comprising:
in response to the SOC comparison result indicating the first SOC being lower than the high SOC threshold, determining the charging direction to be energy flowing from the low-voltage storage system to the high-voltage storage system.

21. An apparatus coupled to one or more processors, the apparatus comprising:
a bidirectional converter configured to operate in a plurality of charging modes;
wherein the plurality of charging modes comprise a first charging mode for energy flowing from a high-voltage rechargeable energy storage system (REESS) to a low-voltage REESS;
wherein the plurality of charging modes further comprise a second charging mode for energy flowing from the low-voltage REESS to the high-voltage REESS;
wherein the bidirectional converter is configured to receive a charging direction indication from the one or more processors;
wherein the charging direction indication is determined based at least in part upon a predicted energy recuperation of an electrified powertrain using telematics data; and
wherein the bidirectional converter is configured to set to one of the plurality of charging modes based at least in part upon the charging direction indication.

22. The apparatus of claim 21, wherein the plurality of charging modes further comprise a third charging mode for no energy transfer.

23. The apparatus of claim 21, wherein the charging direction indication is determined based at least in part upon a first state-of-charge (SOC) of the high-voltage REESS and a second SOC of the low-voltage REESS.

24. The apparatus of claim 21, wherein the charging direction indication is determined based at least in part upon predicted power usage of the electrified powertrain using the telematics data.

25. The apparatus of claim 21, wherein the charging direction indication is determined based at least in part upon a comparison between a determined charging capacity of the high-voltage REESS using the first SOC and an amount of the predicted energy recuperation.
